(19) United States
(12) Patent Application Publication
(10) Pub. No.: US 2003/0072525 A1
(43) Pub. Date: Apr. 17, 2003

(54) Multi-mode fiber bandwidth enhancement using an optical fiber coupler

(76) Inventors: Theodore Sjodin, Waltham, MA (US); Keith Kang, Hollis, NH (US)

Correspondence Address: MORGAN & FINNEGAN, L.L.P., 345 Park Avenue, New York, NY, 10154-0053, US

(21) Appl. No.: 10/183,837

(22) Filed: Jun. 27, 2002

Related U.S. Application Data
(60) Provisional application No. 60/302,205, filed on Jun. 29, 2001.

(51) Int. Cl. G02B 6/26; G02B 6/32

(52) U.S. Cl. 385/31; 385/33

(57) ABSTRACT

An optical apparatus has a laser, an optical fiber, and a guide piece located between the laser and the optical fiber. The laser, the optical fiber, and the guide piece each have a numerical aperature, the numerical aperatures being related so as to modify a multimode light beam passing from the laser to the fiber via the guide piece by preventing coupling of at least some higher order modes to the fiber. A method of enhancing bandwidth in a multi-mode fiber involves passing a light beam through a guide piece having a numerical aperature relationship relative to a laser from which it receives the light beam and a fiber to which it couples the light beam so as to modify modal properties of the light beam and increase bandwidth in a transceiver.

### CROSS REFERENCE TO RELATED APPLICATIONS

This application claims priority under 35 USC 119(e)(1) of U.S. Provisional Patent Application Serial No. 60/302,205 filed Jun. 29, 2001.

### FIELD OF THE INVENTION

This invention relates to lasers and, more particularly, to improving performance in a communications arrangement having multimode lasers.

### BACKGROUND

For longer distance data transmission, two types of lasers are desirable.

The most desirable laser type is a single mode laser where only a lowest order mode is achieved. In this case, the laser output appears like a single spot in the far field. While such lasers are made, in typical surface normal laser configurations, such as VCSELs or Grating Coupled DFB lasers, getting good single mode behavior is challenging and not commercially available at any wavelength. In addition, even if they were commercially available as a single laser, in order to get a large array of such lasers with high-performance, uniform, single-mode behavior with high yield would still be extremely challenging and extremely expensive.

The second type of laser that is useful is one that is highly multimode. A generic sketch of the far field pattern for a two mode laser is shown in FIG. 1 relative to a far field pattern for a highly multimode laser. A multimode laser has different output angles for each of the different modes such as shown in FIG. 2. Each of the modes travels slightly differently down the fiber and, during lasing, power fluctuates between the various modes. If only a few modes are present, the power fluctuation can cause significant noise at the receiving end; if the laser is highly multimode, then the output power is more uniformly spread spatially (in the limit it looks like a plane wave) and so fluctuations are lower. When the different portions of the different modes travel down fiber, they behave differently and the differences can limit the speed and bit error rate of data transmitting down those fiber optic lines. When light from a laser is transmitted into an optical fiber, it is launched into the core of the fiber. Light from a laser emits over some angle of output. The higher order modes often have higher output power at the larger angles than the lowest order mode. It is often the highest angular laser outputs which have the lowest performance.

People have performed modal filtering for a single laser using pin-holes, however pinholes are extremely difficult to align and are unsuitable for use with arrays of lasers, particularly large arrays.

What is needed is a way to eliminate the highest angle outputs from a highly multimode laser leaving the laser light that has the highest performance high speed transmission characteristics left. This needs to be done in a compact fashion in a way that can fit inside of a small module, does not require focusing of light, and is compatible with simultaneously filtering a large number of laser devices that are grouped in a one-dimensional or two-dimensional array.

### SUMMARY OF THE INVENTION

We have devised a way to couple light from lasers to fibers in a way that modifies the modal properties to increase bandwidth for use in high-speed, long distance transceiver arrays.

We have solved the above problem by incorporating guide piece, made of a short (millimeters) thick guiding material, between the laser and the input to the optical fiber. The guide piece allows the high-angle portions of the light beam to diverge so some of the higher order mode lobes are eliminated while others are retained. The result is a mode in which more power is skewed toward the lower order modes and lower power skewed toward the higher order modes.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 shows a far field pattern for a two mode laser relative to a highly multimode laser;

FIG. 2 shows an example of the different output angels for different modes;

FIG. 3 shows the required numerical aperture relationship among the fiber, guide piece and devices; and

FIG. 4 shows an schematic representation of an example implementation we have created and tested applying the relationship described herein.

### DETAILED DESCRIPTION

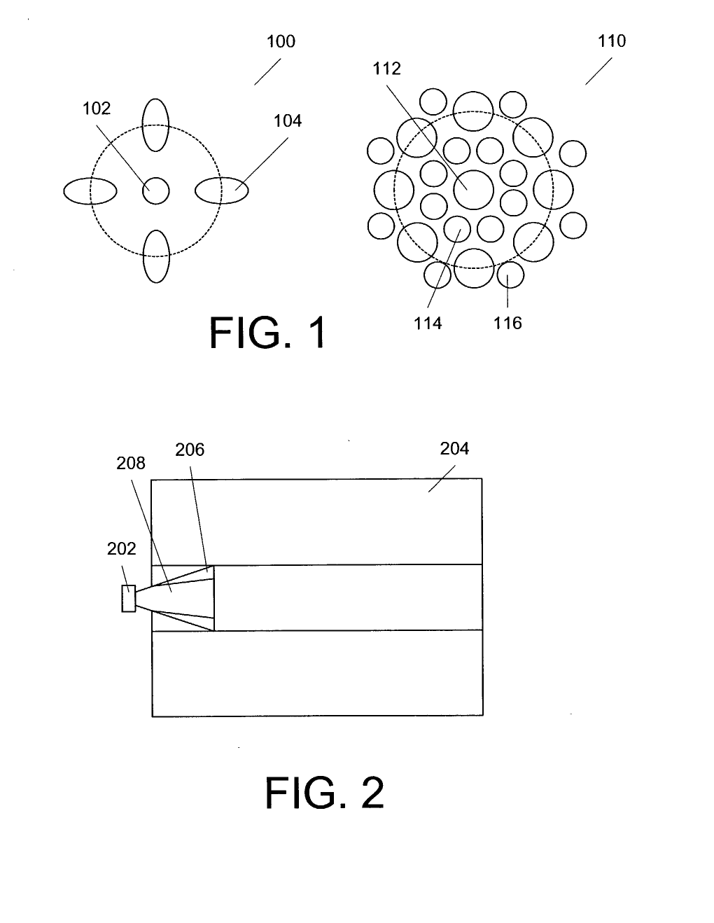

Adverting to the Figures, shown in FIG. 1 is a generic sketch 100 of a far field pattern for a two mode laser relative to a far field pattern for a highly multimode laser. The first order mode lobe (also called a “single mode” lobe) of the two mode beam are denoted by numeral 102 and second order mode lobes denoted by numeral 104. For the far field pattern of the highly multimode laser the single mode lobe is denoted 112, the lower order mode lobes are denoted 114 and the higher order mode lobes are denoted 116.

A multimode laser has different output angles for each of the different modes such as shown in FIG. 2. Each of the modes travels slightly differently down a fiber 204 and during lasering from laser 202, power fluctuates between the various modes. High order mode lobes are detonated as numeral 206 and lower order mode lobes denoted as numeral 208.

As noted above, we have solved the above problem by incorporating guide piece, made of a short (millimeters) thick guiding material, between the laser and the input to the optical fiber. This guide piece can be a short fiber or fiber bundle which can be made in a large enough area to handle many devices simultaneously, an optical window having the appropriate refractive index, or even an optical faceplate. In addition, the guide piece may be a lens filter such that the use of refractive index or lens curvature would assist in varying (i.e. distinguishing or differentiating) the modes. For example, for low order mode lobes, good focus is preferred. Thus, a small lens and/or a lens that does not work well at the periphery may be used to affect coupling of the mode lobes. Finally a fused glass coupler can be used as the guide piece. All of the above examples of guide pieces can be used alone or in combination with each other depending on the implementation.

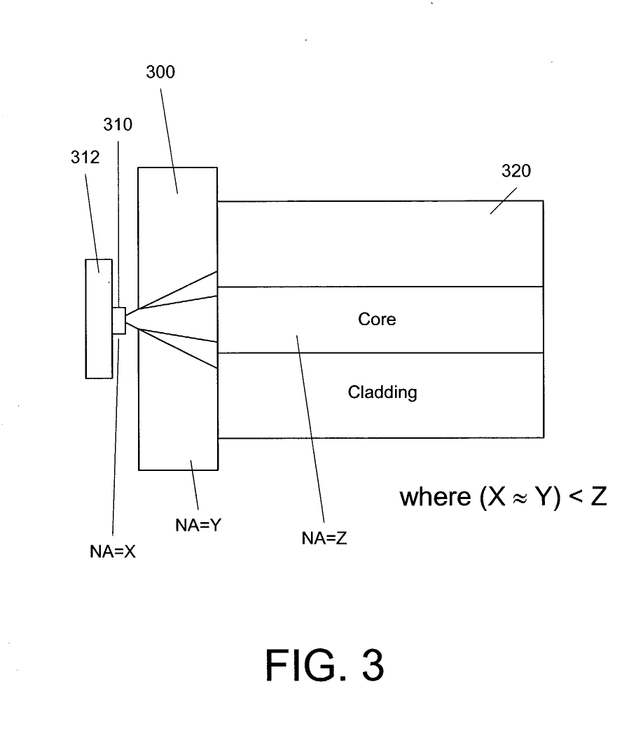

As shown in FIG. 3, a guide piece 300 is fabricated to have a higher numerical aperture (abbreviated “NA”) than both the optical device (here a laser 310 connected to an electronic chip 312 containing the laser's drive and/o control electronics) and the fiber 320. The optical device 310 and fiber 320 are made to be closely matched in numerical aperture. Numerical aperture is a means of expressing the angle of light, which an optical device can accept and allow passing into it or from it. The larger the numerical aperture value, the larger the angle of light that can be accepted.

By placing a thin optical guide piece 300 between the laser 310 and fiber 320 which

1) has a high numerical aperture relative to the laser 310 and fiber 320, and

2) can disrupt the optical modal structure,

the high-angle portions of the light beam are allowed to diverge slightly (i.e. as the modes are disrupted they try to ‘fill’ the coupler). By following this piece 300 with the fiber 320 (which has a lower NA than the coupler), some of the higher order mode lobes are eliminated while others are retained. The result is a mode in which more power is skewed toward the lower order modes and lower power skewed toward the higher order modes. This enhances the data transmission capability of the laser data and allows use of an optical fiber, which has the same numerical aperture as the laser; to capture the light from the laser, yet eliminates some of the power from the higher order modes.

In one particular variant, we use an optical fiber bundle called a faceplate as the guide piece to perform this function, although an ordered fiber array can alternatively be used.

The required characteristics of the guide piece is that it be large enough to cover the entire laser array and that the numerical aperture of the guide piece be larger than that of the lasers and the fibers. FIG. 3 shows the required numerical aperture relationships among the fiber, guide piece and devices in accordance with the invention.

The relationship among Numerical Aperatures (NA) according to the invention can be represented as shown in Equation 1:

NA_{L}≈NA_{F}<NA_{G} (1)

where NA_{L} is the NA of the laser, NA_{F} is the NA of the fiber and NA_{G} is the NA of the guide piece.

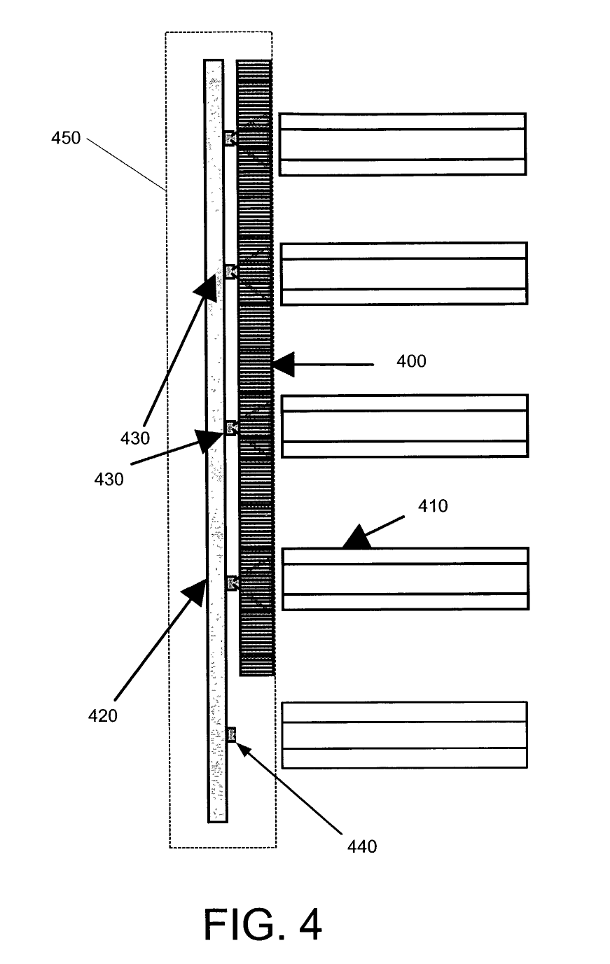

FIG. 4 shows a schematic representation of an example implementation, usable as part of a transmitter or transceiver module, that we have created and tested applying the relationship described in Equation 1, using a laser array 430 and a faceplate 400 as the guide piece. As shown, the laser array is connected to or hybridized with an electrical chip 420 containing at least some of the drive and/or control electronics used for control of laser transmission into the fiber 410. In alternative transceiver variants, the module will also include at least one photodetector 440 that may or may not have a guide piece between it an an optical fiber from which it receives a light beam.

We tested optical links over 1.25 kilometers and saw a bit-error rate decrease from 10⁻⁹ to below 10⁻¹⁴ (a 100,000 fold improvement).

Using our approach, we have achieved various advantages including ease of integration (which decreases cost), manufacturability so the guide pieces can be constructed in arrays, rather than one-at-a-time, thereby also decreasing cost, and allowing highly multimode lasers to achieve superior bit-error rate performance in data transmission.

It should therefor be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention and others are equivalent.

What is claimed is:

1. An optical apparatus comprising:
a laser;
an optical fiber; and
a guide piece located between the laser and the optical fiber;
the laser, the optical fiber, and the guide piece each having a numerical aperature,
the numerical aperatures being related so as to modify a multimode light beam passing from the laser to the fiber via the guide piece by preventing coupling of at least some higher order modes to the fiber.

2. The apparatus of claim 1, wherein the light beam has high angle portions and the guide piece is configured to cause the high-angle portions to diverge as they pass through the guide piece such that at least some higher order mode lobes do not couple to the fiber

3. The apparatus of claim 1, wherein the guide piece is made of a short and thick guiding material such that the thickness is larger than the height of the guide piece.

4. The apparatus of claim 1, wherein the light beam entering the fiber has more power skewed toward a lower order mode and lower power skewed toward a higher order mode.

5. The apparatus of claim 1, wherein the guide piece comprises one of a short fiber, a fiber bundle, an optical faceplate, a lens filter, a fused glass coupler, or an optical window.

6. The apparatus of claim 5, wherein the laser is one of multiple lasers and the guide piece has a surface area large enough to be used for at least several lasers simultaneously.

7. The apparatus of claim 1, wherein the relationship among the numerical aperatures is that the numerical aperature of the laser and the numerical aperature of the fiber are approximately equal to each other and the numerical aperature of the guide piece is greater than the numerical aperature of the laser and the numerical aperature of the fiber.

8. The apparatus of claim 7, wherein the numerical aperature of the guide piece is a result of one of a refractive index or a lens curvature.

9. An apparatus that enhances bandwidth comprising:
a laser;
an optical fiber; and
a guide piece located between the laser and the optical fiber;
wherein the laser and optical fiber have substantially identical numerical aperatures and the guide piece has a numerical aperature larger than the substantially identical numerical aperatures.

10. The apparatus of claim 9 wherein comprises one of a short fiber, a fiber bundle, an optical faceplate, a lens filter, a fused glass coupler, or an optical window.

11. An optical module comprising:
multiple lasers capable of emitting a multimode light beam; and
a guide piece
the guide piece having a higher numerical aperture than an individual laser of the multiple lasers and a fiber into which the individual laser will emit, so that at least some modes of the beam emitted by the individual laser will not couple enter the fiber.

12. The module of claim 11, wherein the individual laser and the fiber have matching numerical apertures.

13. The module of claim 11, further including an electronic chip attached to the laser.

14. The module of claim 11 wherein the module further comprises at least one photodetector.

15. The module of claim 11 wherein the guide piece is a face plate.

16. The module of claim 11, wherein the guide piece is one of a lens filter or fused glass coupler.

17. A method of enhancing bandwidth in a multi-mode fiber, comprising:
passing a light beam through a guide piece having a numerical aperature relationship relative to a laser from which it receives the light beam and a fiber to which it couples the light beam so as to modify modal properties of the light beam and increase bandwidth in a transceiver.

18. The method of claim 17, further comprising:
disrupting the coupling of at least some higher order mode lobes with the fiber.

19. The method of claim 17, further comprising:
skewing power in the light beam such that higher power is skewed toward a lower order mode and lower power skewed toward a higher order mode.

20. The method of claim 17 further comprising diffracting higher order mode lobes to a location beyond a diameter of the fiber so that the higher order mode lobes do not couple with the fiber.
